(19) United States
(12) Patent Application Publication
(10) Pub. No.: US 2010/0157984 A1
(43) Pub. Date: Jun. 24, 2010

(54) WIDEBAND VOIP TERMINAL

(76) Inventors: In Ki HWANG, Daejeon (KR); Hyun Joo BAE, Daejeon (KR); Byung Sun LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/556,696

(22) Filed: Sep. 10, 2009

(30) Foreign Application Priority Data
Dec. 22, 2008 (KR) 10-2008-0131723

(51) Int. Cl. H04L 12/66

(52) U.S. Cl. 370/352

(57) ABSTRACT

A wideband Voice over Internet Protocol (VoIP) terminal is provided. The wideband VoIP terminal includes a synchronous serial interface which processes audio data input thereto or output therefrom in series in synchronization with a clock; and an audio accelerator which encodes or decodes the audio data, wherein the synchronous serial interface includes a buffer buffering the audio data and a buffer controller controlling the buffer and the audio accelerator includes a memory storing the audio data processed by the synchronous serial interface under the control of the buffer controller, a memory controller controlling the memory and an encoder/decoder encoding/decoding the audio data. The wideband VoIP terminal can facilitate the input and output of data.

### CROSS-REFERENCE TO RELATED APPLICATION

This application claims priority from Korean Patent Application No. 10-2008-0131723, filed on Dec. 22, 2008 in the Korean Intellectual Property Office, the disclosure of which is incorporated herein by reference in its entirety.

### BACKGROUND OF THE INVENTION

1. Field of the Invention

The present invention relates to a wideband Voice over Internet Protocol (VoIP) terminal, and more particularly, to a wideband VoIP terminal which can facilitate the input and output of data.

2. Description of the Related Art

Conventional Voice over Internet protocol (VoIP) terminals are mostly designed for use in a narrowband environment. However, as the use of VoIP terminals becomes widespread, the demand for higher audio qualities and the necessity of wideband audio codecs have increased.

Code excitation linear prediction (CELP)-based wideband variable-bit codecs can achieve high audio quality, but inevitably involve a considerable amount of computation, compared to conventional narrowband VoIP terminals.

Conventional narrowband VoIP terminals generally do not have additional processors exclusively designed to process audio data. Instead, core processors process all the audio data. However, the core processors alone may not be able to properly keep up with an increase in the amount of data that needs to be processed for handling wideband audio signals.

In order to address this problem, digital signal processors (DSP) or core processors having improved performance may be used or the operating frequency of VoIP terminals may be maximized. However, these methods may result in an increase in the manufacturing cost or power consumption of VoIP terminals.

With the rapid development of the market for VoIP terminals, the audio quality of VoIP terminals has become one of the most important issues. In order to improve the audio quality of VoIP terminals, wideband audio codecs such as CELP-based wideband variable bit codecs may be used. However, the use of such wideband audio codecs may result in an increase in the amount of computation.

In order to address this problem, the performance of core processors may be improved, or the operating frequency of VoIP terminals may be increased. However, these methods may increase the manufacturing cost and power consumption of VoIP terminals and may thus cause various problems for mobile terminals.

### SUMMARY OF THE INVENTION

The present invention provides a wideband Voice over Internet Protocol (VoIP) terminal which can facilitate the input and output of data.

According to an aspect of the present invention, there is provided a wideband VoIP terminal including a synchronous serial interface which processes audio data input thereto or output therefrom in series in synchronization with a clock; and an audio accelerator which encodes or decodes the audio data, wherein the synchronous serial interface includes a buffer buffering the audio data and a buffer controller controlling the buffer and the audio accelerator includes a memory storing the audio data processed by the synchronous serial interface under the control of the buffer controller, a memory controller controlling the memory and an encoder/decoder encoding/decoding the audio data.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram of a wideband Voice over Internet Protocol (VoIP) terminal according to an exemplary embodiment of the present invention;

FIG. 2 illustrates a data flow diagram showing how the wideband VoIP terminal shown in FIG. 1 processes audio data provided by an external audio processor shown in FIG. 1;

FIG. 3 illustrates a timing diagram for explaining the operation of the wideband VoIP terminal shown in FIG. 1;

FIG. 4 illustrates a data flow diagram showing how audio data processed by the wideband VoIP terminal shown in FIG. 1 can be output to the external audio processor shown in FIG. 1;

FIG. 5 illustrates a timing diagram for explaining the operations of a synchronous serial interface and a quadrature mirror filter (QMF) shown in FIG. 1;

FIG. 6 illustrates a block diagram of an encoder that can be used in the wideband VoIP terminal shown in FIG. 1; and

FIG. 7 illustrates a block diagram of a decoder that can be used in the wideband VoIP terminal shown in FIG. 1.

### DETAILED DESCRIPTION OF THE INVENTION

The present invention will hereinafter be described in detail with reference to the accompanying drawings in which exemplary embodiments of the invention are shown.

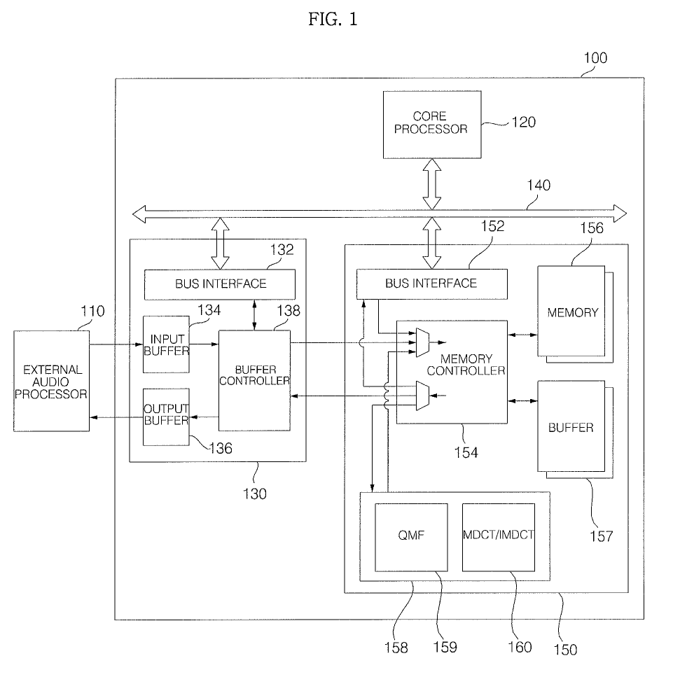

FIG. 1 illustrates a block diagram of a wideband Voice over Internet Protocol (VoIP) terminal 100 according to an exemplary embodiment of the present invention. Referring to FIG. 1, the wideband VoIP terminal 100 may include a core processor 120, a synchronous serial interface 130, a bus 140, and an audio accelerator 150.

The synchronous serial interface 130 may process audio data input thereto or output therefrom in series while being synchronized with a clock signal. For this, the synchronous serial interface 130 may include a bus interface 132, an input buffer 134, an output buffer 136 and a buffer controller 138 controlling the input and output buffers 134 and 136.

The audio accelerator 150 may encode or decode audio data input to or output from the synchronous serial interface 130. For this, the audio accelerator 150 may include a bus interface 152, a memory 156 storing audio data, a memory controller 154 controlling the memory 156 and an encoder/decoder 158 encoding or decoding audio data.

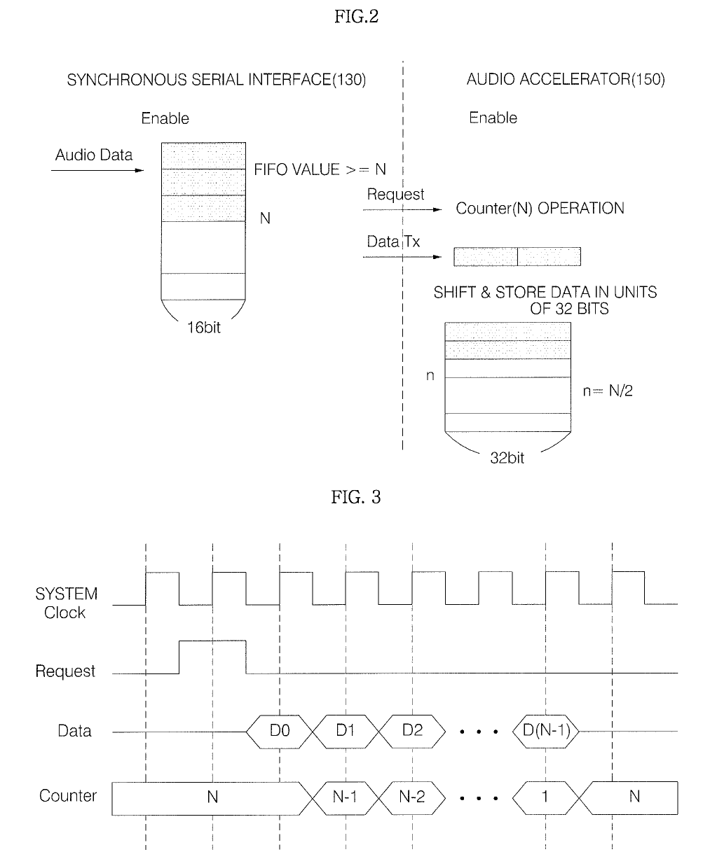

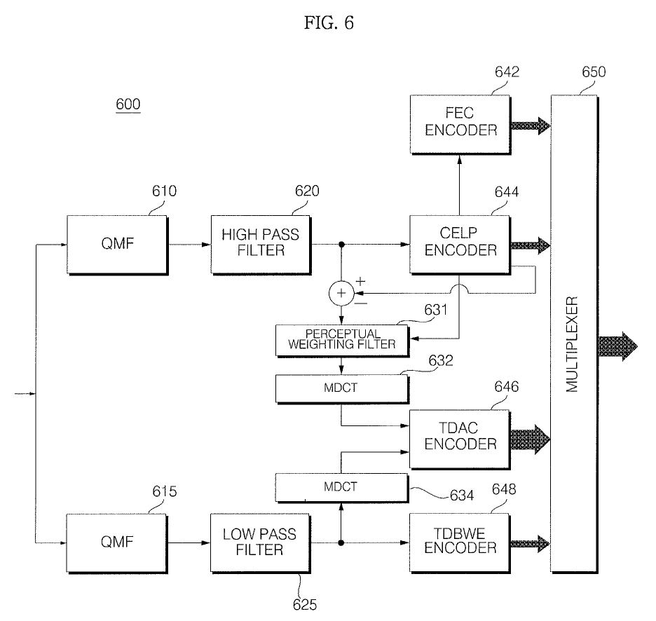

The encoder/decoder 158 may include a quadrature mirror filter QMF 159 and a modified discrete cosine transfer (MDCT) or inverse MDCT (IMDCT) 160. The operation of the encoder/decoder 158 will be described later in further detail with reference to FIG. 6. The operation of the wideband VoIP terminal 100 will hereinafter be described in further detail with reference to FIG. 2.

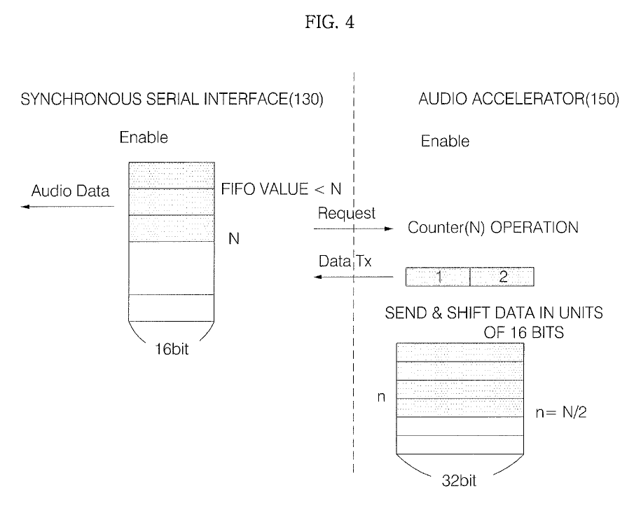

FIG. 2 illustrates a data flow diagram showing how the wideband VoIP terminal 100 processes audio data provided by an external audio processor 110, FIG. 3 illustrates a timing diagram for explaining the operation of the wideband VoIP terminal 100, and FIG. 4 illustrates a data flow diagram showing how the wideband VoIP terminal 100 outputs audio data to the external audio processor 110.

Referring to FIGS. 2 through 4, when a system is initialized, the register values of the external audio processor 110, the synchronous serial interface 130 and the audio accelerator 150 may be initialized.

The external audio processor 110 may determine a sampling interval, may set a protocol for the timing of a frame sync signal and data, and may determine the bit quantity of data to be received from the external audio processor 110 for each sampling period.

The synchronous serial interface 130 may set its register value so as to use the same protocol as that used by the external audio processor 110, and may set a triggering value N for the input buffer 134 to generate a request signal.

The audio accelerator 150 may set its counter register value to be the same as the triggering value N in order to synchronize the synchronous serial interface 130 with valid data.

Once the register values of the synchronous serial interface 130 and the audio accelerator 150 are determined, the enable registers of the synchronous serial interface 130 and the audio accelerator 150 may be activated so that valid audio data can be received from the external audio processor 110.

Data having a predetermined size in bits may be provided to the input buffer 134 of the synchronous serial interface 130 by the external audio processor 110. The buffer value of the input buffer 134 may increase by 1 whenever data is input to the input buffer 134. If the buffer value of the input buffer 134 is the same as or greater than the triggering value N, the input buffer 134 may generate a request signal and may transmit the request signal to the audio accelerator 150, thereby notifying the audio accelerator 150 that N or more valid data are ready to be transmitted.

The synchronous serial interface 130 and the audio accelerator 150 may use the same system clock on the same bus (i.e., the bus 140). Thus, if the request signal generated by the input buffer 134 is synchronized with a system clock used by the synchronous serial interface 130 and the audio accelerator 150, the synchronous serial interface 130 and the audio accelerator 150 may be automatically synchronized with each other.

The synchronous serial interface 130 may transmit data present in the input buffer 134 in synchronization with a system clock that follows the transmission of the request signal generated by the input buffer 134. The transmission of the data present in the input buffer 134 may be performed N times.

The audio accelerator 150 may store data provided by the synchronous serial interface 130 in the memory 156 therein. More specifically, since an operation associated with the core processor 120 is performed on a 32 bit-by-32 bit basis, the audio accelerator 150 may shift data input thereto using a buffer so that the input data can be stored in the memory 156 in units of 32 bits. After receiving the request signal generated by the input buffer 134, the audio accelerator 150 may reduce the triggering value N whenever a system clock is input thereto. The audio accelerator 150 may determine all data input thereto before the triggering value N reaches 1 as being valid.

The memory 156 of the audio accelerator 150 may realize twice as much data as an amount of data corresponding to one frame of a wideband codec. More specifically, since some wideband codecs compare a previous frame and a current frame and process the results of the comparison, the memory 156 of the audio accelerator 150 may use an amount of data corresponding to two frames, i.e., the previous frame and the current frame, at the same time.

Audio data provided by the synchronous serial interface 130 may be divided into two parts (i.e., a narrowband part and a wideband part) by the QMF 159 of the encoder/decoder 158 and may thus be reduced by half.

In order to process current data, the QMF 159 may need 31 previous data and 31 subsequent data. Therefore, in order for the QMF 159 to output data for the first time, a total of 32 input values may be required.

The flow of data shown in FIG. 4 is opposite to the flow of data shown in FIG. 2.

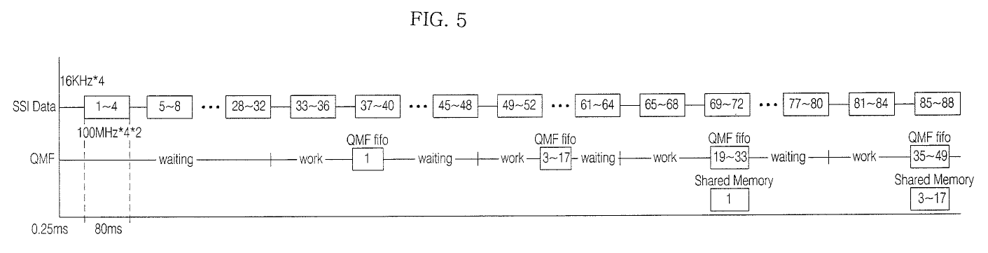

FIG. 5 illustrates a timing diagram for explaining the operation of the wideband VoIP terminal 100. Referring to FIG. 5, a plurality of multipliers and a plurality of adders may be required to realize the functions of the QMF 159. Since narrowband data and wideband data generally have no correlation with each other, they can be processed in parallel and are thus suitable for being implemented as hardware.

In this exemplary embodiment, the QMF 159 may be implemented as a hardware logic. Thus, since there is no need to provide a direct memory access controller in the wideband VoIP terminal 100, it is possible to reduce the integration density of the wideband VoIP terminal 100. In addition, since the QMF 159 generally has more excellent performance than a software QMF, it is possible to improve the general performance of the VoIP terminal 100.

In general, the manufacturing cost of a VoIP terminal including a memory having a large storage capacity is high.

In this exemplary embodiment, the memory 156 may be shared by the QMF 159 and the MDCT/IMDCT 160 of the audio accelerator 150. Thus, there is no need to increase the storage capacity of the memory 156. Therefore, it is possible to reduce the manufacturing cost of the VoIP terminal 100.

The memory 156 may need to have enough storage capacity to process two frames. More specifically, the required storage capacity of the memory 156 may be determined by the amount of data required by the MDCT/IMDCT 160 of the encoder/decoder 158.

Data input to the memory 156 may include data provided by the synchronous serial interface 130 and data provided by the audio accelerator 150.

The amount of data that can be provided to the memory 156 by the synchronous serial interface 130 may be determined by the sampling frequency of the encoder/decoder 158, the size of samples obtained by sampling performed by the encoder/decoder 158 and the triggering value N of the input buffer 134. For example, if the encoder/decoder 158 performs sampling at a sampling frequency of 16 KHz and thus provides 16-bit samples and the triggering value N of the input buffer 134 is 4, 64-bit data (=16*4) may be provided to the memory 156 every 0.25 msec (=4*( 1/16 Khz)) by the synchronous serial interface 130.

Data input to the memory 156 from the input buffer 134 of the synchronous serial interface 130 may be prioritized over any other data to the memory 156 in terms of sharing the memory 156.

In order to efficiently store both data provided by the input buffer 134 of the synchronous serial interface 130 and data provided by the QMF 159 in the memory 156, the data provided by the input buffer 134 of the synchronous serial interface 130 may all be written to the memory 156, and then the data provided by the QMF 159 may be written to the memory 156 so that some of the data previously written to the memory 156 and deemed less valid than the rest of the data present in the memory 156 can be overwritten.

More specifically, referring to FIG. 5, 64-bit data may be input to the memory 156 from the synchronous serial interface 130 every 0.25 msec in synchronization with the system bus 140. Thus, the amount of time required for completing the input of data to the memory 156 from the synchronous serial interface 130 may be (1/system clock frequency)*4.

In this exemplary embodiment, an amount of time corresponding to (1/system clock frequency)*4*2 may be allocated in order to provide sufficient time margins for the memory controller 154 to generate addresses.

Referring to FIG. 5, if 16*64 data are input to the memory 156, the QMF 159 may process 19^{th} through 33^{rd} data. Since 2^{nd}(=33-31) through 64^{th}(=33+31) are required to process the 33^{rd} data, first data may be deemed invalid.

Therefore, the first data input to the memory 156 from the QMF 159 may be written over the first data input to the memory 156 from the synchronous serial interface 130.

Since the data provided by the QMF 159 cannot be readily stored in the memory 156, a buffer 157 capable of storing 16*33 data may be provided for temporarily storing the data provided by the QMF 159.

Even if data provided to the memory 156 by the input buffer 134 of the synchronous serial interface 130 becomes active while storing data provided by the QMF 159 in the memory 156, the data provided by the input buffer 134 may be properly stored in the memory 156 because there is enough time (about 1.25 msec) until the next data provided by the QMF 159 is stored in the memory 156.

Whenever data provided by the QMF 159 is stored in the memory 156, an address may be increased by 0×4 so that the difference between the address of data provided by the synchronous serial interface 130 and the address of data provided by the QMF 159 can be uniformly maintained.

The memory controller 154 may need to include an address generator (not shown) for generating different addresses for different input data. The difference between an address A0 for the input and output buffers 134 and 136 and an address A1 for the QMF 159 may be 64 or greater.

The address generator may determine whether the difference between the address of data to be output from the memory 156 and the address of data provided by the synchronous serial interface 130 is greater than 31 and whether the difference between the address of data to be output from the memory 156 and the address of data provided by the QMF 159 is greater than 31. If the difference between the address of data to be output from the memory 156 and the address of data provided by the synchronous serial interface 130 or the difference between the address of data to be output from the memory 156 and the address of data provided by the QMF 159 is less than 31, the address generator may generate an error signal and may thus allow the memory controller 154 to determine whether to abandon the data provided by the synchronous serial interface 130 or the QMF 159 and whether to resume its operation.

Data processed by the QMF 159 may be subjected to frequency conversion by the MDCT/IMDCT 160. The operation of the MCDT/IMDCT 160 may involve lookup-table search and numerous multiplications and additions and may thus require a considerable amount of computation. In general, MDCT for narrowband data and MDCT for wideband data are hardly correlated to each other, and MDCT requires a considerable amount of computation. Thus, by implementing the MDCT/IMDCT 160 as hardware, it is possible to considerably improve the performance of the MDCT/IMDCT 160.

In order for the MDCT/IMDCT 160 to perform MDCT, 40-msec data may be required. The MDCT/IMDCT 160 may begin to operate when a total of 640 bytes are input thereto from the input buffer 134 of the synchronous serial interface 130 (or when a total of 320 bytes are input thereto from the QMF 159).

If data provided by the MDCT/IMDCT 160 is readily stored in the memory 156, it may collide with valid data provided by the QMF 159. Thus, the data provided by the MDCT/IMDCT 160 may be stored in the memory 156 when the processing of a total of 640 bytes provided by the QMF 159 is complete. For this, the memory controller 152 may include an address generator for handling the data provided by the MDCT/IMDCT 160.

Decoding is almost the opposite of encoding in terms of the flow of data. In a decoding process unlike in an encoding process, the size of data increases. Thus, data must be stored at an address which is 640 bytes greater than the address of data currently being processed.

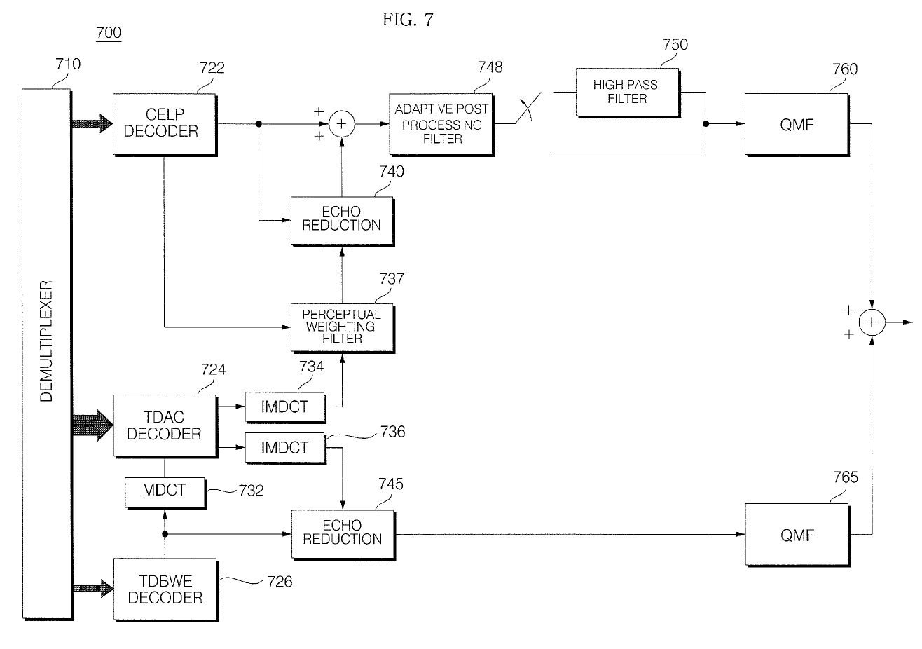

The encoder/decoder 158 will hereinafter be described in detail with reference to FIGS. 6 and 7.

FIG. 6 illustrates a block diagram of an example of the encoder/decoder 158, i.e., an encoder 600. Referring to FIG. 6, the encoder 600 may include a code excitation linear prediction (CELP) encoder 644, a time-domain aliasing cancellation (TDAC) encoder 646, a time-domain bandwidth extension (TDBWE) encoder 648, and a multiplexer 650.

The CELP encoder 644 may generate a low-band signal. The TDBWE encoder 648 may encode a high-band signal input thereto at a bitrate of 14 kbps. In order to improve the quality of the low-band signal and the high-band signal, the TDAC encoder 646 may be used to encode a signal input thereto at a bitrate of 16-32 kbps.

The TDAC encoder 646 may perform frequency transform on a signal corresponding to the difference between an input high-band signal having a frequency of 50-4000 Hz and a signal resynthesized by the CELP encoder 644, i.e., a signal having a frequency of 4000-7000 Hz and may then encode a signal obtained by the frequency transform.

The encoder 600 may also include first and second QMFs 610 and 615 and a high pass filter 620. The first and second QMFs 610 and 615 may receive the input high-band signal and may divide the input high-band signal into a high-band signal and a low-band signal. The low-band signal may be decimated by 2. Thereafter, the decimated low-band signal may be passed through the high pass filter 620 in order to remove frequency components having a frequency of 50 Hz or lower from the decimated low-band signal. A signal obtained by passing the decimated low-band signal through the high pass filter 620 may be encoded at a bitrate of 8-12 kbps by the CELP encoder 644.

A differential signal corresponding to the difference between a preprocessed low-band signal and a resynthesized signal provided by the CELP encoder 644 may be subjected to gain compensation performed by a perceptual weighting filter 631 in order to guarantee a continuity between the spectrums of the differential signal and the input high-band signal. A signal obtained by the gain compensation operation performed by the perceptual weighting filter 631 may be converted into a frequency-domain signal by the MDCT 632.

The input high-band signal may be decimated by 2 and may then be subjected to frequency symmetrization. Thereafter, components having a frequency of 3000 Hz or higher may be removed from the resulting signal by the low pass filter 625. A preprocessed signal provided by the low pass filter 625 may be encoded by the TDBWE encoder 648. Then, the encoded signal provided by the TDBWE encoder 648 may be converted into a frequency-domain signal by the MDCT 634. Low- and high-band MDCT coefficients may be encoded by the TDAC encoder 646.

The FEC encoder 642 may perform an FEC operation on the encoded signal provided by the CELP encoder 644. A signal obtained by the FEC operation, the encoded signal provided by the CELP encoder 644, the encoded signal provided by the TDAC encoder 646 and the encoded signal provided by the TDBWE encoder 648 may be multiplexed by the multiplexer 650.

FIG. 7 illustrates a block diagram of another example of the encoder/decoder 158, i.e., a decoder 700. Referring to FIG. 7, the decoder 700 may include a demultiplexer 710, CELP decoder 722, a TDAC decoder 724, a TDBWE decoder 726, first and second IMDCTs 734 and 736, a perceptual weighting filter 737, first and second echo reduction 740 and 745, an adaptive post-processing filter 748, a high pass filter 750 and first and second QMFs 760 and 765.

The demultiplexer 710 may demultiplex an input signal according to the bitrate of the input signal. If the bitrate of the input signal is 8-12 kbps, the input signal may be decoded by the CELP decoder 722. If the bitrate of the input signal is 14 kbps, the input signal may be decoded by the TDBWE decoder 726. If the bitrate of the input signal is 16 kbps or higher, the input signal may be decoded by the TDAC decoder 724.

At a bitrate of 8-12 kbps, a low-band signal with a frequency of 50-4000 Hz may be restored.

At a bitrate of 14 kbps, the TDBWE decoder 726 may generate a high-band signal. Thereafter, the MDCT 732 may convert the high-band signal into a frequency-domain signal by setting components of the high-band signal with a frequency of 3000 Hz or higher at a value of 0.

At a bitrate of 16 kbps or higher, the TDAC decoder 724 may decode the input signal, and the first and second IMDCTs 734 and 736 may perform inverse frequency transform on the decoded signal. A signal obtained by the first IMDCT 734 may be subjected to perceptual weighting performed by the perceptual weighting filter 737. A band that has not yet been received by the TDAC decoder 724 may be replaced by a signal generated by the TDBWE decoder 726. As a result, a spectrum continuity may be guaranteed.

Decoded signals provided by the CELP decoder 722, the TDAC decoder 724 and the TDBWE decoder 726 may be subjected to echo reduction performed by the first and second echo reduction 740 and 745. An echo-reduced signals provided by the first echo reduction 740 may be subjected to adaptive post-processing filtering performed by the adaptive post-processing filter 748. An adaptive-post-processing-filtered signal provided by the adaptive post-processing filter 748 may be selectively processed by the high pass filter 750. The signal processed by the high pass filter 750 and the echo-reduced signal provided by the echo reduction 745 may be processed by the first and second QMF 760 and 765.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

According to the present invention, it is possible to reduce the system complexity of a wideband VoIP terminal by enabling data input/output (I/O) processing without a requirement of a direct memory access control device.

In addition, it is possible to realize a wideband VoIP terminal even using a cheap core processor and reduce the operating frequency and power consumption of a wideband VoIP terminal.

Moreover, it is possible to reduce the system complexity and power consumption of a wideband VoIP terminal by sharing a memory.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wideband Voice over Internet Protocol (VoIP) terminal, the wideband VoIP terminal comprising:
a synchronous serial interface which processes audio data input thereto or output therefrom in series in synchronization with a clock; and
an audio accelerator which encodes or decodes the audio data,
wherein the synchronous serial interface includes a buffer buffering the audio data and a buffer controller controlling the buffer and the audio accelerator includes a memory storing the audio data processed by the synchronous serial interface under the control of the buffer controller, a memory controller controlling the memory and an encoder/decoder encoding/decoding the audio data.

2. The wideband VoIP terminal of claim 1, wherein the audio data is provided by an external audio processor.

3. The wideband VoIP terminal of claim 1, wherein the synchronous serial interface and the audio accelerator synchronize a request signal with a system clock.

4. The wideband VoIP terminal of claim 1, wherein the memory has a sufficient storage capacity to store two frames of the audio data at the same time.

5. The wideband VoIP terminal of claim 1, wherein the encoder/decoder includes a quadrature mirror filter (QMF) dividing the audio data into wideband components and narrowband components and separately processing the wideband components and narrowband components.

6. The wideband VoIP terminal of claim 5, wherein the audio data processed by the synchronous serial interface and the audio data processed by the QMF are stored in the memory at different times so as to overlap with each other partially.

7. The wideband VoIP terminal of claim 5, wherein the memory controller includes an address generator generating different addresses for the audio data processed by the synchronous serial interface and the audio data processed by the QMF.

8. The wideband VoIP terminal of claim 7, wherein, if the difference between the address of the audio data processed by the synchronous serial interface and the address of the audio data processed by the QMF is less than a predefined value, the address generator generates an error signal.

9. The wideband VoIP terminal of claim 5, wherein the encoder/decoder further includes a modified discrete cosine transfer (MDCT) performing frequency conversion on the audio data processed by the QMF.

10. The wideband VoIP terminal of claim 9, wherein the memory controller includes an address generator generating different addresses for the audio data processed by the synchronous serial interface and a number of frequency conversion coefficients provided by the MDCT.

11. The wideband VoIP terminal of claim 3, wherein the buffer stores the audio data provided by the external audio processor and generates the request signal in order to indicate that the stored audio data is ready to be transmitted.

12. The wideband VoIP terminal of claim 6, wherein the audio data processed by the synchronous serial interface is prioritized over the audio data processed by the QMF and is thus stored in the memory ahead of the audio data processed by the QMF.

13. The wideband VoIP terminal of claim 5, wherein the encoder/decoder further includes a buffer temporarily storing the audio data processed by the QMF.

14. The wideband VoIP terminal of claim 5, wherein the encoder/decoder further includes a first encoder generating a low-band signal, a second encoder generating a high-band signal and a third encoder improving the qualities of the low- and high-band signals.

15. The wideband VoIP terminal of claim 14, wherein the encoder/decoder further includes a multiplexer multiplexing encoded signals provided by the first through third encoders.
